(19) United States
(12) Patent Application Publication
(10) Pub. No.: US 2024/0305050 A1
(43) Pub. Date: Sep. 12, 2024

(54) FEMALE TERMINAL AND MANUFACTURING METHOD OF SUCH A TERMINAL

(71) Applicant: Aptiv Technologies AG, Schaffhausen (CH)

(72) Inventors: Sylvain BOSSUYT, BOUTIGNY PROUAIS (FR); Lionel DOMERGUE, MAINVILLIERS (FR); Quentin CORDIER, ILLIERS L'EVEQUE (FR); Abdelaaziz ELMANFALOUTI, Elancourt (FR)

(21) Appl. No.: 18/585,923

(22) Filed: Feb. 23, 2024

(30) Foreign Application Priority Data
Mar. 8, 2023 (EP) 23160761.5

(51) Int. Cl. H01R 24/38; H01R 13/11; H01R 43/16; H01R 101/00

(52) U.S. Cl. CPC H01R 24/38; H01R 13/111; H01R 43/16; H01R 2101/00

(57) ABSTRACT

A female terminal for electrical power connections of a vehicle including a contact portion configured to be coupled, along a mating direction, to a male terminal. The contact portion of the female terminal has contact blades. Each contact blade has a contact region with two contact areas, each of these two contact areas forming a protrusion with an apex at the level of which an electrical contact is made with the male terminal. Further, the apices of the protrusions of some of the contact blades are offset in the mating direction from the apices (19) of the protrusions of other contact blades. A method of manufacturing such a female terminal is also presented.

### CROSS-REFERENCE TO RELATED APPLICATION

This application claims the benefit of and priority to European Patent Application No. 23160761.5 titled “Female Terminal and Manufacturing Method of Such a Terminal” filed on Mar. 8, 2023, the contents of which are incorporated by reference herein.

### TECHNICAL FIELD

The disclosure relates to the field of power connection systems for motor vehicles. For example, the disclosure can find an application in power connectors, such as those used to charge a rechargeable electric or hybrid vehicle battery or as those used in interconnect power circuits connecting batteries, converters, electrical motors, and any other power device of a vehicle.

### BACKGROUND

A charge plug generally includes female power electrical terminals for the charging of the vehicle and possibly electrical terminals intended to transmit an electrical signal which makes it possible to control the power supply of the charge plug.

In the field of power connection systems for motor vehicles, the female terminals for the charge plugs are often machined by bar turning from a bar of conductive material, for example a copper alloy. The female terminals can also be made by cutting, stamping, embossing a blank in an electrically conductive material in sheet, and rolling up a cut-out region of the blank. The present disclosure concerns a female terminal of the latter type.

As illustrated by FIG. 1, such a female terminal 1P is intended to be mated to a male terminal 2P at one side and to be connected, at another side, to a connecting element 3P (e.g. a cable, a busbar, or any other conductive element). Thus, it has a body including a fixing portion 4P and a contact portion 5P. The fixing portion 4P is configured to connect the female terminal 1P electrically and mechanically to the conductive element 3P. The contact portion 5P of the female terminal 1P includes a socket 6P with contact blades 7P configured to be coupled, along a mating direction MD, to the contact portion 8P of the male terminal 2P. In the applications concerned by this disclosure, the male terminal 2P has a pin 9P with a contact portion 8P having an essentially cylindrical shape with a symmetrical axis of revolution. The contact portion 5P of the female terminal 1P is formed of the portion cut out in the sheet metal portion and rolled up around a central axis CA, parallel to the mating direction MD, to form an inner region 17P intended to receive at least a part of the contact portion 8P of the male contact 2P. The contact blades 7P, the number of which is greater than or equal to eight, are cut out in this sheet metal portion. Each contact blade 8P extends between a junction region 11P, by means of which it is connected to the rest of the body of the female contact 1P, and a free end 12P.

Each contact blade 7P has a contact region 13P with one contact area forming a contact point where an electrical contact is made with the male terminal 2P. To conduct high current intensities between female and male terminals 1P, 2P without excessive heating, the resistance at such a contact point must be minimized. For this purpose, a sufficient contact force must be applied at each contact point. The contact blades 7P of the female terminal 1P must therefore exert sufficient force on the pin 9P of the male terminal 2P. However, the greater the force exerted by the contact blades 7P of the female terminal 1P on the pin 9P, the greater the insertion forces of the male terminal 2P into the female terminal 1P. For example, this can result in a mating force between female and male terminals 1P, 2P of about 30 N, for male terminals 2P with a diameter of 8 mm, and even 45 N for male terminals 2P with a diameter of 12 mm. However, when the insertion forces become too high, several problems can occur such as a premature wear of the contact areas due to the high friction, difficulties experienced by a user to mate the male and female connectors together, etc.

To reduce the mating forces, contact blades are generally used that are long enough to have greater flexibility. However, this has at least two drawbacks: the possible increase in electrical resistance at the contact points and longer connectors in the longitudinal direction of the contact blades.

There is therefore a need to design and manufacture connectors capable of transmitting ever higher current intensities, without compromising safety due to excessive heating and without excessively increasing their size.

This disclosure is intended to meet at least partially one of these needs.

### SUMMARY

A female terminal capable of meeting at least some of the needs discussed above is presented herein. This female terminal is capable of transmitting high electric currents through more electrical contact points, thus reducing the risk of excessive heating. However, due to the offset of the contact points, and therefore of the friction points, of some contact blades in relation to others, the initial insertion force is lower than if all the contact points were at the same level, in the mating direction. Therefore, thanks to this female contact, it becomes also possible to reduce the length of the contact blades, without increasing excessively the initial insertion force.

This female terminal optionally further includes any of the features of claims 2-10, considered independently of one another or in combination with one or more others.

A method of manufacturing a female terminal is also presented herein.

The number of contact blades is greater than or equal to 2. For example, the number of contact blades is equal to 4 or 6 blades. However, the disclosed solution is particularly advantageous when it becomes difficult (due to the manufacturing process, the dimension of the terminal, the robustness requirement, etc.) to increase the number of blades. For example, the disclosed solution is particularly advantageous when the number of which is greater than or equal to 8.

The apices of the protrusions of a same contact blade can be offset in the mating direction, or the apices of the protrusions of some of the contact blades can be offset in the mating direction from the apices of the protrusions of other contact blades, or the apices of the protrusions can be offset in the mating direction both on a same contact blade and from the apices of the protrusions of other contact blades.

### BRIEF DESCRIPTION OF THE DRAWINGS

The present invention is now described, by way of example with reference to the accompanying drawings, in which:

FIG. 1 is an isometric drawing of male and female terminals according to the prior art.

FIG. 2 is an isometric drawing of a first example of a socket of a female terminal according to some embodiments.

FIG. 3 is a side view of the female terminal shown in FIG. 2 according to some embodiments.

FIG. 4 is an isometric drawing of details of a contact region of the female terminal shown in FIGS. 2 and 3 according to some embodiments.

FIG. 5 is a front view of the mating interface of the female terminal shown in FIGS. 2 to 4 according to some embodiments.

FIG. 6 is an isometric drawing of a second example of a socket of a female terminal according to some embodiments.

FIG. 7 is a front view of the mating interface of the female terminal shown in FIG. 6 according to some embodiments.

### DETAILED DESCRIPTION

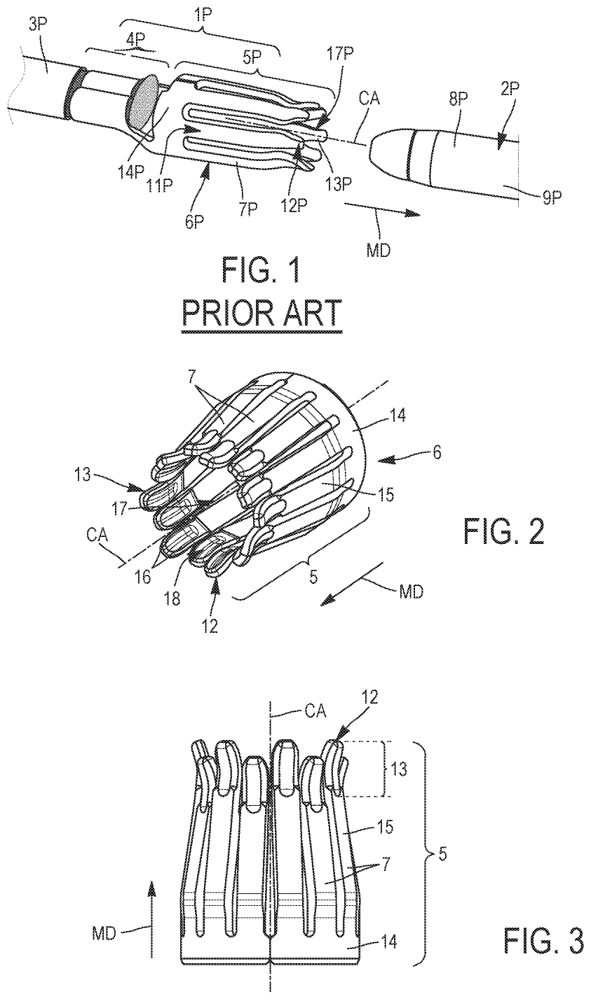

A first example of a socket 6 of a female terminal 1 is shown in FIG. 2. The remaining portion of the body, and in particular the fixing portion (not shown) of female terminal 1 is similar, or the same, to that of the female terminal 1P shown in FIG. 1. For example, the fixing portion is designed to be crimped over a cable 3.

For example, the female terminal 1 represented in FIG. 2 is configured for mating with a male terminal 2 having a diameter of 12 mm.

As represented in FIGS. 2 and 3, the female terminal 1 is formed by cutting and stamping an electrically conductive material in sheet form. This material is composed for example of a copper alloy, in the form of a sheet whose thickness is between 0.6 and 1.6 mm, and is for example preferentially equal to 1.2 mm.

For example, the female terminal 1 must make it possible to maintain a heating temperature lower than 60° C. when, mated with a male terminal 2, it is passed through by an electrical current of 300 amperes or higher. However, even if, for this purpose, a relatively thick sheet of electrically conductive material is used, the coupling effort between the female terminal 1 and a male terminal 2 must be less than 45 Newtons.

Furthermore, this female terminal 1 must satisfy a wear test over at least 50 coupling/uncoupling cycles with a male terminal 2.

To these constraints is added the fact that female and male terminals 1, 2 must comply with the IP2X standard, and possibly that the cost of production of the female terminals 1 be controlled, and even reduced.

All this has been considered in designing the female terminal 1 described hereinbelow.

After cutting and shaping, the female terminal 1 has a contact portion 5 in the form of an essentially cylindrical socket 6. The socket 6 is formed by bending and rolling the sheet metal portion cut in the sheet of electrically conductive material. The contact portion 5 is linked mechanically to the fixing portion. This contact portion 5 includes a base 14 and a plurality of resilient contact blades 7. The base 14 and the plurality of resilient contact blades 7 define an inner region 17 of the socket 6.

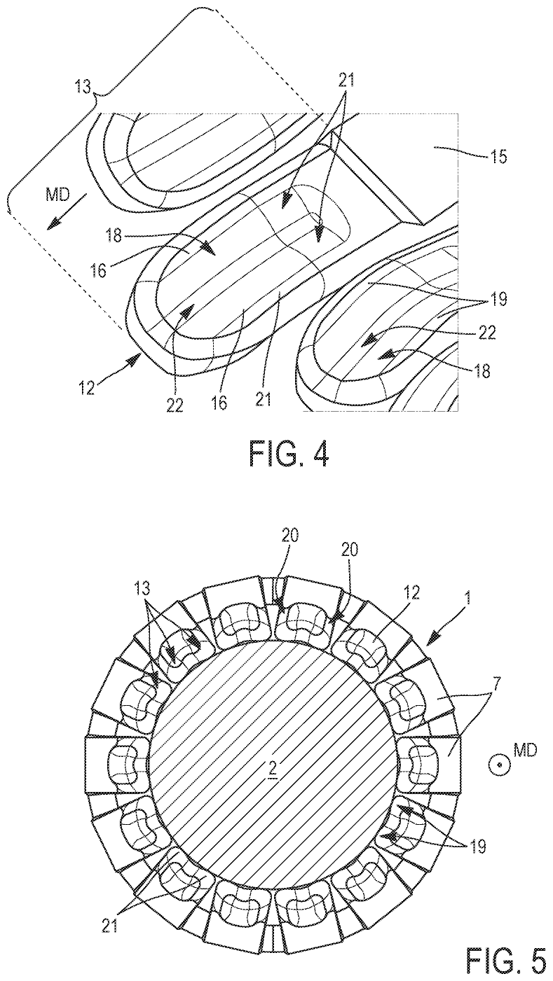

In the example represented, there are fourteen contact blades 7, distributed essentially symmetrically about a central axis CA, parallel to a mating direction MD (corresponding to the insertion of a pin 9 of a male terminal 2 into the socket 6). Each contact blade 7 extends longitudinally, between a base 14 and a free end 12. Each contact blade 7 is linked to the rest of the female terminal body only at the base 14. In other words, each contact blade 7 is separated from its nearest neighbours by a gap which extends between the base 14 and the free end 12 of the contact blades 7 and which mechanically and electrically insulates them from one another. Between the base 14 and the free end 12 of the contact blades 7, the cross section of the contact blades 7 is essentially rectangular, up to a contact region 13 shown in details in FIG. 4. The portion 15 of each contact blade 7 having such a rectangular section is relatively straight and is inclined towards the central axis CA, from the base 14 to its free end 12. The contact region 13 of each contact blade 7 extends between this straight portion 15 and its free end 12.

As represented in FIGS. 2 to 4, the contact region 13 of each contact blade 7 is shaped so as to form two contact areas 16. The contact areas 16 of each contact blade 7 is closer from the central axis CA than its free end 12 and closer from the central axis CA than its straight portion 15. In other words, the contact region 13 of each contact blade 7 is curved with a convex shape essentially directed towards the central axis CA. Further, each contact areas 16 of each contact blade 7 is shaped so as to form a protrusion 21 extending into the inner region 17. The contact region 13 of each contact blade 7 has an inner face 18, from which the protrusions 21 extend into the inner region 17. Each one of the protrusions 21 has an apex 19. Each apex 19 is designed to make a contact point with the contact portion 8 of the male terminal 2. Therefore, the female terminal 1 has 2N apices 19, where N is the number of contact blades 7. In the illustrated example, N=14, and the female terminal 1 has 28 apices, each forming a contact point.

For example, the contact region 13 of each contact blade 7 is laterally limited by two convex rounded longitudinal edges 20 and the protrusions 21 extend longitudinally over the length of each contact area 16. A longitudinal engravement 22 separates two neighbouring protrusions 21. For example, the contact regions 13 are shaped by embossing prior to rolling up the contact portion 5 about a central axis CA.

For example, the apices 19 of the two contact areas 16 of a single contact region 13 are positioned on a circle extending in a plane perpendicular to the mating direction MD.

The apices 19 of the protrusions 21 of some of the contact blades 7 are offset in the mating direction MD from the apices 19 of the protrusions 21 of other contact blades 7. For example, as illustrated in FIG. 3, every second contact blade 7 is longer, so that alternately, when running a circle around the central axis CA, one contact blade 7 is longer than the two adjacent contact blades 7. For example, the short contact blades 7 are 17.5 mm long and the long contact blades 7 are 19 mm long.

Then for example, the apices 19 of the two contact areas 16 of each long contact blade 7 are positioned on a circle extending in a plane perpendicular to the mating direction MD, and the two contact areas 16 of each short contact blade 7 are positioned on another circle extending in another plane perpendicular to the mating direction MD, these two planes being parallel to each other and spaced apart by a distance corresponding to the length difference between the shorter and the longer contact blades 7.

This design makes it possible for example, to reduce the length of the longest contact blades 7 by 20%, for a same mating force.

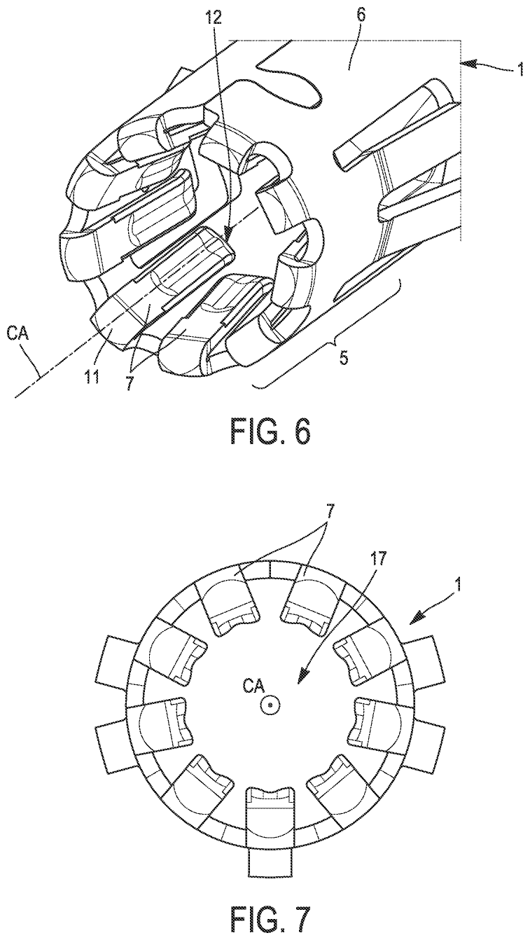

A second example of a socket 6 of a female terminal 1 is represented in FIGS. 6 and 7. The remaining portion of the body, and in particular the fixing portion (not shown) of this female terminal is similar, or the same, to that of the female terminal shown in FIG. 1.

The female terminal 1 of this second example differs mainly from the female terminal 1 of the first example, by its dimensions, its number of contact blades 7 and the shape of its contact blades 7. For the sake of conciseness, the features that are the same in both embodiment examples are not repeated.

For example, the female terminal 1 represented in FIGS. 6 and 7 is configured for mating with a male terminal 2 having a diameter of 8 mm.

For this example, the number of contact blades is 9 and the female terminal 1 has 2N=18 apices 19 and contact points.

In this example, each contact blades 7 is bent back in the inner region 17 so that its free end 12 is located closer to the socket 6 or the fixing portion, than its junction region 11.

For example, the contact blades 7 are bent back prior to rolling-up the contact portion 5 about a central axis CA.

This design has the advantage of considerably shortening the length of the female terminal 1. This design can be used with a larger number of contact blades 7.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A female terminal for electrical power connections of a vehicle with a terminal body, the female terminal comprising:
a fixing portion, configured to connect the female terminal electrically and mechanically to another conductive element, and
a contact portion configured to be coupled to a male terminal along a mating direction having an essentially cylindrical shape with a symmetrical axis of revolution and configured to establish an electrical connection by contact with the male terminal, wherein the contact portion is formed of a sheet metal portion rolled up around a central axis parallel to the mating direction to form an inner region intended to receive at least part of the contact portion of the male terminal, wherein the contact portion has at least two contact blades being cut out of this sheet metal portion, wherein each contact blade extends between a junction region and a free end, by means of which it is connected to the terminal body, wherein each contact blade has a contact region with two contact areas each forming a protrusion extending into the inner region and each of the protrusions having an apex, wherein apices of some of the protrusions are offset in the mating direction from the apices of other protrusions, wherein each protrusion extends longitudinally over a length of each contact area, and wherein a longitudinal engravement separates two adjacent protrusions of a contact blade.

2. The female terminal in accordance with claim 1, wherein the apices of some of the contact blades are further offset in the mating direction from the apices of the protrusions of other contact blades.

3. The female terminal in accordance with claim 1, wherein a number of contact blades is greater than or equal to 8.

4. The female terminal in accordance with claim 1, wherein a number of contact blades is greater than or equal to 9.

5. The female terminal in accordance with claim 1, wherein a number of contact blades is greater than or equal to 14.

6. The female terminal in accordance with claim 1, wherein the apices of the two contact areas of a single contact region are positioned on a circle extending in a plane perpendicular to the mating direction.

7. The female terminal in accordance with claim 6, having short contact blades and long contact blades, wherein long contact blades are longer that two adjacent short contact blades, wherein the two contact areas of each long contact blade are positioned on a circle extending in a plane perpendicular to the mating direction, wherein the two contact areas of each short contact blade are positioned on another circle extending in another plane perpendicular to the mating direction, and wherein these two planes are parallel to each other and spaced apart by a distance corresponding to a length difference between the short contact blades and the long contact blades.

8. The female terminal in accordance with claim 1, wherein the contact blades are bent in the inner region with their free ends located closer to the fixing portion than their junction region.

9. The female terminal in accordance with claim 1, wherein the contact region of each contact blade is curved such that its free end is further from the central axis than its contact areas.

10. The female terminal in accordance with claim 1, wherein the contact region of each contact blade has an inner face from which the protrusions extend into the inner region and the inner face is laterally limited by two convex rounded longitudinal edges.

11. The female terminal in accordance with claim 1, wherein the protrusions extend longitudinally over at least a portion of the contact area of each contact blade.

12. A method of manufacturing a female terminal for electrical power connectors of a vehicle, comprising the steps of:
providing a sheet of conductive material;
forming the sheet of conductive material into a contact body having:
a fixing portion configured to connect the female terminal electrically and mechanically to another conductive element,
a contact portion with two or more contact blades extending in a longitudinal direction between a junction region and a free end;
forming a contact region with two contact areas on each contact portion, wherein each of these two contact areas form a protrusion and each of the protrusions have an apex, wherein apices of certain protrusions are offset in the longitudinal direction with respect to the apices of other protrusions, wherein each protrusion extends longitudinally over a length of each contact area, and wherein a longitudinal engravement separates two neighbouring protrusions of a contact blade; and
rolling up at least the contact portion about a central axis to form an internal region configured for receiving at least a part of the contact portion of a male terminal.

13. The method of claim 12, wherein the contact blades are bent back toward the fixing portion prior to rolling up at least the contact portion about the central axis.
